(19) United States
(12) Patent Application Publication
(10) Pub. No.: US 2017/0144466 A1
(43) Pub. Date: May 25, 2017

(54) ROUND FURNACE FOR SUBLIMATION TRANSFER

(71) Applicant: Photo U.S.A. Corporation, Fremont, CA (US)

(72) Inventors: Peng Anping, Fremont, CA (US); Wang Pengyu, Beijing (CN)

(73) Assignee: Photo U.S.A. Corporation, Fremont, CA (US)

(21) Appl. No.: 15/362,601

(22) Filed: Nov. 28, 2016

Related U.S. Application Data
(60) Provisional application No. 62/332,968, filed on May 6, 2016.

(30) Foreign Application Priority Data
Nov. 25, 2015 (CN) ZL201520951612.9

(51) Int. Cl. B41M 5/382; B44C 3/00

(52) U.S. Cl. CPC B41M 5/382; B44C 3/00

(57) ABSTRACT

A sublimation furnace has a cylindrical shape with a V-shaped access opening covered by a door having a curved cover and triangular top that rotate about a longitudinal furnace axis. Curtains on each side of the access opening reduce heat loss while loading or unloading workpieces from a rotating support. A plenum is formed between inner and outer walls of the furnace with a fan circulating heated air through the furnace and plenum and through holes in the rotating support. A furnace control panel is mounted on a multi-axis support fastened to the furnace or a movable support holding the furnace.

### CROSS-REFERENCE TO RELATED APPLICATIONS

The application claims the benefit under 35 U.S.C. §119(e) to Provisional Patent Application No. 62/332,968 filed May 6, 2016, and Chinese Patent Application ZL2015 20951612.9 filed Nov. 25, 2016, the entire contents of which are incorporated herein by reference.

### BACKGROUND

The following description relates to a circular furnace for heat transfer or sublimation transfer of an image to a suitable substrate, whether of stainless steel, aluminum, ceramics, plastics or other metal or non-metallic surfaces.

Sublimation transfer may be achieved by single part presses configured for the shape of a specify workpiece that is to receive a sublimation image. But such transfer presses handle one workpiece at a time and are thus time consuming to operate and that both increases production costs and reduces the potential production volume so as to make individual presses unsuitable for sublimation transfer of large volumes of images onto workpieces.

Intermediate volumes could use an oven with a door, but that was time consuming because the operator had to load one or more workpieces into the oven, close the door, activate the oven which had to reach operating temperature to perform the dye transfer of images, and then had to reduce the oven temperature, open the door and remove the imaged workpieces. Such use of batch ovens is time consuming, thermally inefficient and an inefficient use of the operator's time.

Larger volumes may be achieved by continuously operated elongated, tunnel furnaces. Traditional thermal heating furnaces for sublimation transfer involve elongated, tunnel-like furnaces having a chain belt passing through the length of the furnace with articles placed on the belt for heating and the resulting sublimation transfer. The elongated, tunnel-like furnace may have an entrance portion to receive the workpieces and materials bearing the sublimation image to be transferred to the workpiece. The elongated furnaces also have a middle heated portion that include heaters and may also include hot air circulating elements with both the heaters and air circulation arranged so that the workpiece can be heated sufficiently rapidly and uniformly to bring the workpiece and transfer material to a temperature suitable for sublimation transfer and to maintain that temperature for a time sufficient for the sublimation transfer to occur. A third, downstream section of the heater allows removal of the imaged workpieces from the chain belt, usually at a temperature lower than the sublimation transfer temperature but high enough to avoid any damaging effects to the workpiece and sublimation transfer image and low enough to allow safe handling of the workpieces.

While the long, tunnel structure provides for a simple arrangement, the length requires a large area of floor space and large volume, with an even larger clearance area around at least the heated portion of the long tunnel furnace. The length and size of the tunnel makes the furnace difficult to install and once installed it is difficult to move or transport the long furnace and equipment needed to heat the various sections and move the chain belt. Because the long furnace has workpieces inserted at the inlet end and removed at the other, distant outlet end of the furnace, two or more workers must work together to operate the furnace and that increases the cost of labor and of production. There is thus a need for a more efficient furnace design for sublimation transfer, and a need for a more compact sublimation furnace.

The elongated furnaces typically have a control panel at the inlet end that allows adjustment of the temperature, air circulation, chain speed and other furnace features. The inlet location may impede simultaneous loading of the furnace and adjustment of the furnace by two different persons. Moreover, the control panel is fixed in position, limiting access to the panel and making it difficult to view furnace operating parameters displayed on the control panel. There is thus a need for an improved furnace control panel.

### SUMMARY

To overcome the problems of the prior art, a circular thermal furnace is provided. The thermal transfer furnace is circular in shape so as to resemble a cylinder. The circular furnace has a pie-shaped, wedge shaped or V-shaped furnace access opening through which a single operator may insert workpieces onto a rotating workpiece support and remove finished workpieces from that rotating workpiece support. The narrow part of the pie-shape, wedge shape or V-shape is toward the center of the furnace with the wide part at the outer, side wall of the furnace. A thermally insulating curtain may hang down from each opposing side of the access opening to help reduce heat loss while loading and unloading workpieces, with the curtain being light enough that it does not damage the workpieces as they rotate with the support inside the furnace.

The rotating workpiece support advantageously has a plurality of air holes extending through the support to circulation of heated air through the support and around the workpieces. Heat is provided by electrical resistance heaters and may include a top heater along the top of the furnace, and/or a bottom heater located along the bottom of the furnace and below the rotating workpiece support. The heated air in the furnace is circulated by a fan at the top and/or bottom of the furnace. The walls of the circular furnace advantageously have a double wall construction with an inner wall and outer wall that provide an annular air plenum around the outside of the furnace and a preferably at least around the top of the furnace with heated air circulating through that plenum between the inner and outer walls. The double wall construction does not extend to the wedge-shaped door. One or both of the inner and outer walls may be insulated, and preferably the outer wall is insulated or has heat shields sufficient to allow human contact without burning. An access opening in the top wall, preferably at the center of that wall, allows air in the furnace to be drawn upward by a top fan that circulates the air outward through the top of the plenum and downward between the inner and outer sidewall of the furnace. At least one ventilation opening through the bottom, inner wall of the furnace allows the circulating air to enter the furnace working volume below the rotating workpiece support. The air passes through the air holes in the rotating workpiece support, around the workpieces and up toward the top of the furnace to complete the heated air circulation path. The top fan top preferably draws air from the working furnace chamber while bottom fan blows air toward the rotating workpiece support and top of the furnace.

The door has a generally triangular top with a curved outer wall section depending downward from the outer and wider end of the triangular top, with the top and outer wall of the door larger than the access opening in the furnace and sized to block the wedge-shaped access opening of the round furnace. The apex or tip of the triangular top preferably comprises a bearing surface encircling a mounting boss on one of the top and bottom of the furnace to allow the door to rotate about the longitudinal axis of the furnace to cover and uncover (open and close) the access opening to the furnace. Rollers or sliding supports on the top or outer wall of the door help support the weight of the door on the outside of the furnace. A viewing port may be provided in the door or other portions of the furnace, although if placed in the door then a mating viewport need not be located on the inner wall of the furnace to allow viewing of the workpieces in the chamber of the furnace.

The furnace is preferably mounted on a support frame of various configurations, but preferably an open frame having three to five vertical legs supported by optional braces extending between the various legs. A rectangular support frame with four legs is believed suitable. The bottoms of the legs preferably have rollers and more preferably wheels, to allow movement of the frame and furnace. At least one of the rollers advantageously has a lock to prevent rotation of the roller to which the lock is attached. Advantageously the frame has a top surface on which the bottom of the furnace rests. The support frame may have vertically extending retention flanges fitting around the outside of the bottom of the furnace to help prevent the furnace from sliding laterally off the support frame. A circular flange extending along a bottom sidewall of the furnace is believed suitable.

A control panel is optionally mounted to the support frame and preferably mounted to one of the legs or a cross-brace extending between two of the legs. The control panel is preferably movably mounted using a mounting bracket allowing multi-axis rotation, preferably rotation about two vertical axes and one horizontal axis. The multi-axis rotation bracket preferably has an L-shape with the top of the long leg of the L shaped bracket mounted vertically downward from a cross-brace extending between two of the legs and located about midway between two front legs. A first rotatable joint allows rotation about a first longitudinal axis along the vertical leg of the L shaped bracket. That first rotation allows the short leg of the L shaped bracket to be oriented anywhere in a horizontal plane containing that short leg of the bracket, and allows a second longitudinal axis of that leg to be oriented in that horizontal plane at various positions. The short leg of the L shaped bracket is preferably horizontal and has a second rotatable joint allowing rotation about the axis of that short leg in the horizontal plane. At the end of the short leg is a third rotatable joint, oriented vertically, allowing rotation along a third axis parallel to the first axis and parallel to the long leg of the L shaped bracket. The control panel is mounted to the end of the short leg and mounted to rotate about the third axis.

The legs of the L shaped bracket are preferably tubular with control wires passing through the tubes with sufficient room in the tubes and wire length to allow bending and/or rotating of the wires at the three rotatable joints while maintaining electrical contact and signal contact through the wires. This multi-axis rotation bracket allows the control panel to be rotated to either side of the support frame and furnace along the first axis. It also allows the control panel to extend inward or outward from the periphery of the support frame by rotation along the first axis. It further allows the control panel to face left, right or forward by rotation about the third axis so the panel can be viewed from any angle in the horizontal plane. Combined rotation about the second and third axis allows the control panel to be rotated in a vertical plane and allows a user to view the control panel by looking downward from various angles. The multi axis rotation about two vertical axes and one horizontal axis allows great flexibility in accessing the control panel and viewing information displayed on the control panel, while reducing the flexing of wires passing through the support bracket so as to maintain electrical and signal communication.

The round, rotating workpiece support allows a compact furnace shape that may be moved easily and that occupies limited floor space. The rotating workpiece support allows continuous production with a single user to load and unload workpieces. The wedge-shaped access opening allows easy access to insert and remove workpieces of various heights. The door allows multiple heating for multiple revolutions of the rotating workpiece support, as needed. The movable support bracket on the control panel allows flexibility in placing the furnace at various locations while orientating the control panel to allow easy monitoring and access to the control panel without interfering with the loading or unloading of the furnace while allowing continuous production of the furnace.

In more detail, there is provided a thermal furnace for sublimation transfer that includes a cylindrical furnace having a longitudinal axis and a circular outer sidewall with an outer top and an outer bottom opposite the top and joined to the outer sidewall. The furnace has an inner sidewall spaced inward of the outer sidewall to form a side plenum between the inner and outer sidewalls. The furnace also has an inner top spaced inward of the outer sidewall to form a top plenum between the inner and outer tops. The side and top plenums are interconnected around at least a part of the outer periphery of the inner sidewall. The side plenum is in fluid communication with a workspace inside the inner sidewall through a plurality of sidewall ventilation openings extending through the inner sidewall. The top plenum is in fluid communication with the workspace through a ventilation opening in the top inner wall. The furnace also has first and second top side parts inclined relative to each other to form opposing sides of a V-shaped top access opening that extends through the inner and outer tops to an outer periphery of the tops. The first top side part joins the outer and inner tops to close the top plenum along the first top side part and the second top side part join the outer and inner tops to close the top plenum along the second top side part of the V-shaped access opening. The furnace also has a first sidewall edge extending downward from an outer end of the first top side part and has a second sidewall edge extending downward from the second top side part with a bottom sidewall edge joining the first and second sidewall edges to form a side access opening extending through the first and second sidewalls. The first and second sidewall edges join the inner and outer sidewalls to close the side plenum along the first and second sidewall edges while the bottom sidewall edge joins the inner and outer sidewalls to close the side plenum along the bottom sidewall edge. The furnace may also have a movable door having a door top sized to cover the V-shaped access opening in the top of the furnace and rotatably mounted at the center of the top. The door has a depending cover large enough to cover the side access opening in the furnace sidewall and located close to that side access opening. The depending cover may be curved to allow rotation of the cover to pass along the outer periphery of the sidewall when the cover is rotated about the longitudinal axis to cover and uncover the side and top access openings. The furnace may further include a rotating workpiece support inside the furnace and below the bottom sidewall edge, the rotating workpiece support having a plurality of air holes extending through the support. The furnace may also have a motor located outside the furnace and mechanically coupled to the rotating workpiece support as well as an electrical resistance heating element located inside the furnace and rated to heat the interior of the furnace and workpieces in the furnace to a temperature in the range of at least 100° C. to 250° C. The furnace may also have a fan circulating air through the plenum.

In further variations, the furnace, when viewed along a radial axis has the first and second sidewall edges parallel to each other and the bottom edge horizontal so as to form a rectangular access opening. The door top is preferably triangular shaped but may be trapezoidal shaped. The door top may be rotatably mounted at the center of the outer top. The door cover may be movably supported on a ledge extending along an outer periphery of at least one of the inner and outer walls. The heating element may be below the rotating workpiece support and above a bottom of the inner wall, or it may extend along the top inner wall, or it may extend along the sidewall. The ventilation opening in the top inner wall may comprise a ventilation opening at the center of the wall. The plurality of ventilation openings extending through the sidewall is preferably located below the rotating workpiece support. The top ventilation opening in the top inner wall may include a ventilation opening at the center of the inner wall and the fan may have a motor located outside the furnace that is in mechanical communication with a fan blade located above that top center ventilation opening, with the fan blade configured and rotated so as to draw air from the workspace into the top plenum. The fan may circulate air out the top ventilation opening, then through the plurality of ventilation openings in the sidewall and then upward through the air holes in the rotating workpiece support. The outer bottom may have an annular shape which joints to the inner sidewall which extends in a direction along the longitudinal axis of the furnace a distance beyond the outer bottom, with a bottom of the inner sidewall closed by an inner bottom, and with the rotating workpiece support being located above the outer bottom and the inner bottom, with at least the inner sidewall and inner top being insulated.

In still further variations, the furnace may include a support frame having sufficient wheels to allow movement of the furnace on a surface. The furnace may further include a control panel for the furnace, with the control panel mounted on a multi-axis support that includes a first leg having a first rotatable joint rotating about a first longitudinal axis of the first leg and connected to either the furnace or a support frame on which the furnace is placed. The multi-axis support may also include a second leg connected to the first leg at a location which allows the first joint to rotate the second leg about the first longitudinal axis, where the second leg has a second rotatable joint rotating about a second longitudinal axis of the second leg. The multi-axis support may also include a third leg connected to the second leg at a location which allows the second joint to rotate the third leg about the second longitudinal axis, the third leg having a third rotatable joint rotating about a third longitudinal axis of the third leg, with the control panel being connected to either the third leg or third joint to rotate about the third axis. Advantageously the first and third longitudinal axes are parallel and the second longitudinal axis is perpendicular to the first axis. Advantageously, the first rotatable joint is connected to the support frame and the first axis is vertical.

There is also disclosed a thermal furnace for sublimation transfer having a cylindrical furnace with a longitudinal axis and a circular outer sidewall with an outer top and an opposing outer bottom. The furnace has first and second top side parts inclined relative to each other to form opposing sides of a V-shaped top access opening in the outer top which top access opening extends to an outer periphery of the top. The furnace further has a first sidewall edge extending downward from an outer end of the first top side part and has a second sidewall edge extending downward from the second top side part with a bottom sidewall edge joining the first and second sidewall edges to form a side access opening in the sidewall. The furnace also has a movable door with a door top sized to cover the V-shaped access opening in the top of the furnace and rotatably mounted about the longitudinal axis of the furnace. The may also have a depending cover large enough to block the side access opening in the furnace sidewall. The depending cover is advantageously curved to allow rotation of the cover to pass along the outer periphery of the sidewall when the cover is rotated about the longitudinal axis. The furnace preferably also has a rotating workpiece support inside the furnace and below the bottom sidewall edge where the rotating workpiece support has a plurality of air holes extending through the support. The furnace also preferably has a motor located outside the furnace and mechanically coupled to the rotating workpiece support as well as an electrical resistance heating element located inside the furnace and a fan circulating air through the plenums.

In further variations this last furnace, preferably has an inner top inward of the outer top and having a V-shaped access opening in the inner top located to correspond with the V-shaped access opening in the outer top. The space between the inner and outer tops forms a top plenum. The first and second top side parts extend between the outer and inner tops to close the top plenum at the V-shaped top access opening that now extends through the inner and outer tops. This variation also preferably has an inner sidewall located inward of the outer sidewall and having a side access opening corresponding to the side access opening of the outer sidewall. The space between the inner and outer sidewalls forms a side plenum with the first and second sidewall edges and bottom sidewall edge extending between the first and second sidewalls to close the side plenum at the side opening that now extends through the outer and inner side walls. The top plenum intersects the side plenum to place the two plenums in fluid communication. Further variations include a top ventilation opening in the inner top which top ventilation opening in fluid communication with a workspace enclosed by the inner top and inner sidewall. The top ventilation opening is also in fluid communication with the top plenum. The bottom sidewall preferably also has a plurality of sidewall ventilation openings extending therethrough to place the side plenum in fluid communication with the workspace, preferably with the rotating table being above at least some of those ventilation openings in the sidewall.

In still further variations, the heater may be located at least at one of the top of the inner wall or below the rotating workpiece support. A wheeled support may also be provided on which the furnace is placed. The furnace may also include a control panel for the furnace, with the control panel mounted on a multi-axis support mounted to one of the furnace or the wheeled support. The multi-axis support may include a first leg having a first rotatable joint rotating about a first longitudinal axis of the first leg and connected to either the furnace or a support frame on which the furnace is placed. The multi-axis support also may include a second leg connected to the first leg at a location which allows the first joint to rotate the second leg about the first longitudinal axis, where the second leg has a second rotatable joint rotating about a second longitudinal axis of the second leg. The multi-axis support may also include a third leg connected to the second leg at a location which allows the second joint to rotate the third leg about the second longitudinal axis, the third leg having a third rotatable joint rotating about a third longitudinal axis of the third leg, where the control panel is connected to either the third leg or third joint to rotate about the third axis. The first and third longitudinal axes are preferably parallel and the second longitudinal axis is preferably perpendicular to the first axis to form a U-shaped arrangement of the legs, which legs may be of varying length. Rotational stops may be provided on one or more of the legs and/or rotational joints in order to limit rotation to such angles as 180° or 90°. The legs may comprise tubes with electrical wires and/or sensor wires for the furnace passing through the tubes, or the legs may have such wires connected to the legs and/or joints.

### BRIEF DESCRIPTION OF THE DRAWINGS

These and other advantages and features of the invention will be better appreciated in view of the following drawings and descriptions in which like numbers refer to like parts throughout, with a part number list provided at the end of the description, and in which:

FIG. 1 is perspective view of a furnace with a furnace door in an open position;

FIG. 2 is a sectional view of the furnace of FIG. 1, taken along section 2-2;

FIG. 3 is a front view of the furnace of FIG. 1 showing the furnace door in a closed position and the furnace on a movable support frame with a monitor connected to that support frame;

FIG. 4 is a perspective view of the furnace of FIG. 1 with curtains and a support rail for the door; and

FIG. 5a is a front view of a control panel on a multi-axis support mounted to a stationary support with the control panel to the right of the stationary support;

FIG. 5b is a side view of the control panel and support of FIG. 5a with the control in front of the stationary support;

FIG. 5c is a front view of the control panel and support of FIG. 5a with the control panel to the left of the stationary support;

FIG. 5d is a top view of the control panel and support of FIG. 5a inclined at an angle to the stationary support; and

FIG. 6 is a partial perspective view of a workpiece on a rotating workpiece support in the furnace of FIG. 1.

### DETAILED DESCRIPTION

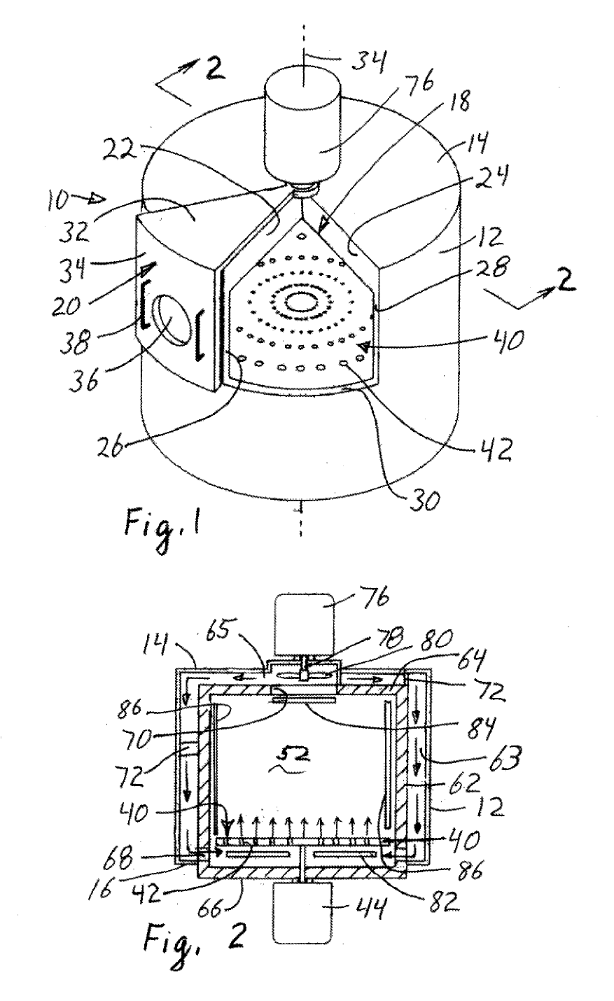

Referring to FIGS. 1-3, a circular thermal furnace 10 is shown having a cylindrical shape with a curved, circular, outer sidewall 12 extending vertically, a generally circular, outer top 14 and an opposing outer bottom 16, each preferably planar and horizontal. An access opening 18 to the inside of the furnace 10 is removably covered by a door 20. The access opening is shown as a wedge shape, pie-shape or V-shape, with two opposing, straight side parts 22, 24 in the outer top 14 angled so the sides form part of a V-shape access opening in the top. Because the top access opening 18 need not extend all the way to the center of the top 14 and most likely ends before the rotational axis 35, the shape of the access opening may not be a pure rectangle. As used herein, the reference to a V-shaped or wedge shaped or pie-shaped or triangular shaped access opening 18 includes a trapezoidal shape. Regardless of the specific shape. The side parts 22, 24 extend to the outer sidewall 12 which has two opposing and preferably vertical side edges 26, 28 in the sidewall 12 and a preferably horizontally cut bottom edge 30 connecting the side edges 26, 28. Since the sidewall 12 is curved as part of the round housing of the furnace the bottom edge 30 is actually curved. If viewed along a radial axis the bottom edge 30 looks like a straight line and if view along a longitudinal axis of the furnace the bottom edge 30 is curved as it forms part of the sidewall 12.

The door 20 covers the access opening 18 has a top 32 that is preferably triangular in shape with a depending side covering 34 extending downward from the outer edge of the top and curving along the outer sidewall 12. The door is sized to movably cover the access opening 18. The door top 32 and side cover 34 are preferably but optionally insulated. The apex of the triangular door top 32 preferably has a circular mount to encircle a vertical, longitudinal axis 35 of the furnace 10 to facilitate rotation of the door 20 about axis 35 to cover and uncover the access opening 18. A viewing port 36 may be placed in the wall 34 of the door. The port 36 has suitable glass to allow viewing of the hot furnace interior and is preferably insulated glass so the exterior does not burn a user's hand upon contact with the viewing port 36. Handles 38 allow a user to move the door 20 to open and close the door and access opening 18. Because the triangular shape or V-shape of the access opening 18 includes a trapezoidal shape, the reference herein to a triangular-shaped door 20 or top part 32 also includes a trapezoidal shape which preferably, but optionally extends to and at least partially around the longitudinal furnace axis 35. Regardless of the specific shape, the door 20 preferably rotates about the longitudinal axis so the curved cover 34 may move along the outer periphery of the furnace to cover and uncover access opening 18. A trapezoidal shaped cover 20 may require a curved rotational support or a member or members extending to the axis 35 so the cover 20 may rotate substantially about the longitudinal axis 35, about the periphery of the furnace 10 at radius at which the cover 20 is located.

The furnace 10 has a rotating workpiece support 40 with a plurality of air holes 42 therethrough forming air passages through the support. The rotating workpiece support 40 is preferably circular with its outer periphery close to the inner wall of the furnace 10, but a multi-sided support may be used. The air holes 42 are shown arranged in concentric circles about the axis 35 through the center of the rotating workpiece support 40. The air holes 42 may increase in diameter toward the outer periphery of the rotating table. Advantageously the air holes 42 are sized and spaced to provide a uniform flow of heated air through the air holes 42. As used herein, a uniform flow preferably has about a 5% to 10% variation in the volume of heated air flowing through the nearest air holes surrounding a particular air hole. The support is preferably made of steel, aluminum, titanium, ceramic or other suitable material of sufficient strength to support the workpieces during use while not reacting with the workpieces or normal environment within the furnace 10.

The rotating workpiece support 40 is rotated by motor 44 that rotates a shaft 46 that extends through the bottom of the furnace and is connected to the support 40. The shaft 46 is preferably aligned with longitudinal axis 35. The motor is preferably mounted to the bottom of the furnace or to a support frame described later.

Referring to FIG. 2, the furnace 10 preferably has a multiple wall construction which, with the door 20, encloses a workspace 52 that preferably has a cylindrical shape. An inner side wall 62 is located inward of the outer wall 12 toward the axis 35, and forms a cylinder concentric with that outer wall to form an annular plenum 63 between the inner and outer sidewalls. An inner top wall 64 is located inward of the top wall 14 along axis 35 and a bottom wall 66 is opposite the top inner wall 64. The space between the outer top wall 14 and inner top wall 64 form a top plenum 65 having the general shape of a disk (with a pie section missing). The top and bottom inner walls 64, 66 join the top and bottom periphery of the inner side wall 62 to enclose most of the cylindrical workspace 52. The outer periphery of the top, generally disk shaped plenum 65 overlaps with the top of the annular plenum 63 so the two plenums 63, 65 are interconnected and air can flow between them. The top and side plenums 63, 65 extend around an outside of the upper portion of the workspace 52 but do not extend across the access opening 18 as the plenums end at the side parts 22, 24 of the top plenum 63, and the side edges 26, 28 and bottom edge 30 of the side plenum 65. The top inner wall 64 has a pie-shaped or wedge shaped or V-shaped gap in it as the top inner wall 64 joins the side parts 22, 24 defining the access opening 18 in the top 14. Likewise, the inner sidewall 62 has a curved but generally rectangular segment missing at the location of the access opening 18 that is bounded by the vertical side edges 26, 28 and bottom edge 30 defining the access opening. The side parts 22, 24 extend between and join the outer and inner tops 14, 64.

The side edges 26, 28 and bottom edge 30 extend between and join the outer and inner side walls 12, 62. The annular space between the inner and outer sidewalls 12, 62 form the annular plenum 63. Thus, the annular plenum 63 may extend around the entire circumference of the bottom portion of the furnace 10, but the annular plenum does not extend around the entire circumference of top portion of the furnace because that plenum is bounded by the side edges 26, 28 and the bottom edge 30. The top, disk-shaped plenum 65 also does not extend around the entire circumference of the outer top 14 as the side parts 22, 24 limit that plenum to a disk with a wedge shaped portion that is missing. If the shape of the access opening 18 changes, the corresponding shape of side parts 22, 24 and sidewall edges 26, 28 and bottom edge 30 may also change as will the shape of the plenums 63, 65. While the depicted embodiments show the top plenum 65 as a generally planar, disk shaped volume, the top plenum may comprise one or more radially oriented spokes in the event that the top plenum is used mainly to direct hot air to the side plenum 63. The side plenum 63 is preferably circular and annular below the bottom edge 30, and annular and circular but for the side opening formed by side edges 26, 28 for the volume of the side plenum 63 above the bottom edge 30.

Still referring to FIG. 2, the inner bottom wall 66 may be located inside of the outer bottom wall 16, with the wall 16 forming a circular disk. But preferably the inner bottom wall 66 extends below the outer bottom wall 16 so the bottom wall 16 forms an annular ring extending between the outer side wall 12 and the inner side wall 62, adjacent the inner bottom wall 66. The inner bottom wall 66 thus extends below the outer bottom wall 16 in the depicted embodiment.

A ventilation opening 70 in the top inner wall 64 allows air to flow from the workspace 52 to the top plenum 65. As needed, supports 72 may extend between the inner and outer side walls 12, 62 forming the side plenum 63, and may extend between the outer top and inner top walls 14, 64 forming the top plenum 65. The supports 72 are advantageously shaped and located to reduce the blockage of air flow through the plenums 63, 65 while supporting and maintaining the distance between inner and outer walls 12 and 62, 14 and 64, respectively. The preferred embodiment preferably has a the top ventilation opening or openings 70 at the center of the inner top wall 64, preferably within the circumference of the fan blade circulating the hot air as described later.

The inner walls 62, 64, 66 enclosing the workspace 52 are preferably, but optionally thermally insulated. Kao wool is believed to be a suitable insulation. The inner walls 62, 64, 66 are preferably double walls each having an inner and outer wall with insulation in between. The outer walls 12, 14, 16 may be insulated or not insulated.

A plurality of bottom vent openings 68 extends through the inner side wall 62 adjacent the bottom wall 16. The bottom vent openings 68 are preferably located below the vertical level of the rotating workpiece support 42 a distance so that a majority of the air entering the bottom vent opening 68 passes underneath the rotating workpiece support 40. A top ventilation opening 70 extends through the inner top wall 64 to place the work space 52 in fluid communication with the top plenum 65.

A top fan circulates heated air through the plenum. The top fan may include fan motor 76 rotating fan drive shaft 78 that passes through top outer wall 14 to rotate a fan blade 80 located in the top plenum 65. Preferably, the fan blade 80 is configured and the direction of rotation is selected so the fan blade 80 draws heated air from the workspace 52 into the top plenum 63. The fan blade may be placed in a recess in the top plenum 65 or at an opening to that recess as shown in FIG. 2. The top fan may be positioned elsewhere as long as it is in fluid communication with the plenums 63, 65 to circulate air in the plenums.

A first, bottom heater 82 is located below the rotating workpiece support 40 and is typically supported on standoffs attached to one or both of the inner bottom 62 or bottom 12, but could be supported off of the inner sidewall 62. A second, top heater 84 may optionally be located at the top of the workspace 52 and is typically supported on standoffs attached to one or both of the tip inner wall 64 or top outer wall 14. Third, side heaters 86 may be provided along the sides of the inner sidewall 62, preferably offset from that wall by suitable metal or ceramic standoffs. The side heaters extend generally parallel to the rotational axis 34 and are preferably evenly spaced about the portion of the inner wall 64 that forms the access opening 18 and is inside the curtains formed by strips 90. The workspace and workpieces may be heated by the bottom heater alone, the top heater alone, the side alone, or any combination of the heaters. Unused top, bottom or side heaters may be omitted entirely from the furnace or provided for optional use at the discretion of the user. The heaters 82, 84, 86 are preferably electrical resistance heaters. The specific number, location and wattage of the heaters will vary with the specific application and size of the furnace 10. Heaters having a wattage of about 8 KW is believed suitable for a furnace 10 having an outer diameter of about 1.2 meters (about 4 ft.) and a height of about 1.8 meters (about 6 ft.) with an interior workspace diameter of about 1 meter by 0.3 meter to provide a working maximum furnace temperature of about 250° C. (about 480° F.). The rotating workpiece support 40 for the above furnace 10 may be about 0.1 meter in diameter, or larger, but no so large as to contact the interior sidewall 62 or any heaters 86 mounted on that sidewall. As heaters 86 on the sidewall reduce the effective diameter of the workspace 52, there are advantages to omitting the side heaters. The current supplied to the resistance heaters will vary with the available line voltage, but is preferably 240 V, 3phase current for the U.S., or 380V, 3 phase current or optionally 208 V, 3 phase current if available. A PID temperature controller is believed suitable to control the temperature to within about 3° C., plus or minus.

Advantageously, the furnace 10 has a stainless steel outer shell 12, 14, 16, preferably with a painted exterior surface. The interior surface is also preferably made of stainless steel.

In use, the top fan draws air through top ventilation opening 70 and causes it to flow outward from the top plenum 65 and downward through the annular plenum 63, through the bottom vent openings 68, upward around the outside of rotating workpiece support 40 and upward through the openings 42 in the support 40, around and past the workpieces and back through the top ventilation opening 70. As the plenums do not extend through the door 30 there is no circulation through the space occupied by the door when the door is closed.

Referring to FIG. 4, a plurality of strips 90 may depend from a support 92 mounted along the bottom edges of side parts 22, 24, or mounted to those sides. The strips 90 form generally planar curtains in the undeformed state. The curtains restrain heat loss when the door 20 is open. The strips 90 are long and flexible and made of a thermally insulating material which will vary with the operating temperature of the furnace 10 and the nature of the workpieces. Curtains made of strips 90 of silicon are believed suitable, with strips about one inch wide and as long as needed to approach (but preferably not touch) the top surface of the rotating workpiece support 40, believed suitable. The strips 29 are preferably flexible enough that they may part around workpieces rotating through the plane of the curtain and soft enough that they do not damage the workpieces being heated.

Referring to FIGS. 1 and 4, the door 20 rotates about the longitudinal axis 35, preferably on a bearing mounted to the outside of the furnace's top which bearing encircles the axis 35 and drive shaft 78 of fan motor 76 and is preferably located between the top 14 and fan motor 76. The side cover 34 of the door 30 may be vertically supported on a support rail 94 extending outward from or connected to the outer sidewall 12. The support rail 94 provides a ledge on which the bottom of the side cover 34 of door 30 may rest and along with the cover may move. Rollers or skids may be optionally mounted to either the support rail 94 or the door cover 34 to make movement easier, with those parts preferably being interposed between the top of the support rail 90 and the bottom of the side cover 34 of the door 30. While the support rail 94 is shown as an outwardly extending ledge, the outer wall 12 could be offset inward or recessed inward to form the support rail 94. Advantageously, the inside of door 20 does not seal against the outside of the furnace top 14 and sidewall 12. The sliding fit of the door 20 to the furnace 10 may be and preferably is very close in order to reduce heat loss, but the lack of a seal allows for thermal expansion of the door 20 because it cools when rotated away from access opening 18, and heats up when covering the access opening 18 and the door must open and close without binding. As used herein, the door 20 is close enough to the outer top 14 or outer sidewall 12 to allow rotation of the door to cover and uncover the access opening 18 without binding the door open or closed in light of thermal expansion effects, while reducing the thermal loss to acceptable levels because hot air flows out the gap between the door and sides 22, 24 and edges 26, 28, 30 when the opening 18 is covered. A gap of less than a quarter of an inch is preferred and provides a simple definition of “close” suitable for use herein. Airflow seals may be provided on the outer top 14 and outer sidewall 12 or on the outer edges or sides of the top 32 and door 34 to reduce the flow of heated air through any gap between the door and the top 14 and sidewall 12, but such seals are optional.

In use, the rotating workpiece support 40 and circular furnace 10 provide a compact heating furnace with a single entrance and exit. Thus, a single operator can add or remove workpieces to the furnace and the furnace occupies a small space. The circular sidewall configuration provides a compact, space-saving footprint. The rotation speed of support 40 may be adjusted using the motor 44 or intervening belt or gear drives so that the sublimation on a workpiece occurs within one revolution of the support 40, or within a fixed number of revolutions or within a fixed time regardless of the number of revolutions. A planetary gear drive offers significant gear ratios to allow various sized, electric motors to be used.

Handles 38 allow easy opening and closing of the door 20. Moving the door 20 sideways allows direct access to the rotating workpiece support 40 to make insertion and removal of workpieces easy, as well as cleaning of the furnace and workpiece support 40. The view port 46 allows users to visually check workpieces or to use optical sensors to check temperatures inside the furnace. The support 40 rotates continuously so that workpieces move relative to the heaters and that causes any unevenness in the heat from heaters 82, 84, 86 to spread out and be more uniform. The circulation of air from the bottom to the top of the furnace also helps make the heating of the moving workpieces more uniform. The hot air rising from the lower heater(s) 82 aids circulation but the top fan and fan blade 80 increase that air circulation throughout the workspace 52 and plenums 63, 65 and accelerate that circulation and accelerate the flow of air over that occurring when the fan is not used. The circulation of the heated air through the plenums 65, 63 also helps maintain the elevated temperature of the workspace 52, and helps reduce the insulation of both the inner and outer furnace walls and further helps to both quickly heat the workspace 52 and maintain the temperature of the workspace 52. The curtains with flexible strips 90 help maintain the operating temperature and reduce heat escaping from the furnace when the cover 20 is open for inserting workpieces into the furnace or removing them from the furnace. The ability to activate heaters 82, 84 on the bottom, top or both the bottom and top of the furnace offers a wide range of heating methods and temperatures. The ability to use optional side heaters 86 with or without the

[symbol]

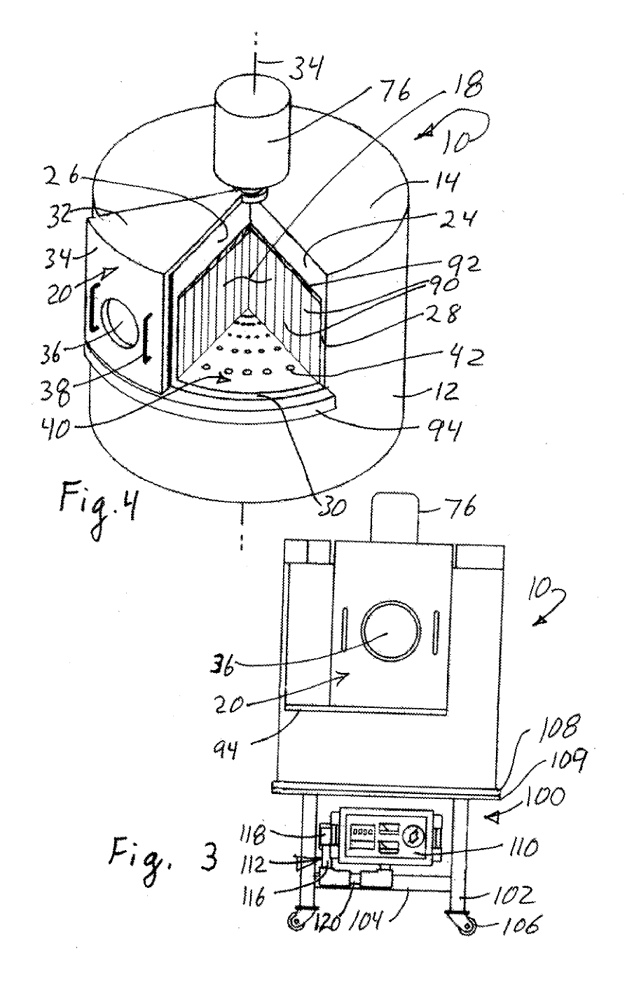

Referring to FIGS. 3 and 5a-4c, the furnace 10 advantageously is held by a wheeled support. The support preferably comprises an open support frame 100, but an open framework need not be used. The support frame 100 advantageously has from three to five support legs with the depicted embodiment having four support legs 102, located at each corner of a square. Cross braces 104 extend between each leg 102. The legs 102 are preferable tubular, metal legs. The bottom end of each leg advantageously has a wheel 106 to allow movement of the frame 100 and furnace 10. At least one of the wheels 106 has a lock mechanism to releasably lock the when and prevent rotation in order to resist movement of the frame and furnace. The upper end of the frame 100 preferably has one or more vertically extending retention flanges 108 fitting around the outside of the bottom of the furnace 10 to help prevent the furnace from sliding laterally off the support frame. A flange 108 having an L-shaped cross-section and extending along bottom 16 and sidewall 12 of the furnace is believed suitable. The flange 108 may be supported by a top plate 109 on the frame 100, with the top plate 109 configured to accommodate and support the bottom of the furnace 10. Thus, the wheeled frame 100 allows the furnace 10 to be moved laterally on a floor by merely unlocking the wheel(s) 104 and pushing or pulling the furnace into the desired location.

The fan motor 76, rotating motor 44 and heaters 82, 84 are controlled by control panel 110 mounted on a positionable support bracket 112. Various system sensors such as thermal sensors, rotation speed sensors, fan speed sensors, heater current sensors, revolution counters for the support 40, and other sensors may also controlled by the panel 110 and various sensor values or device conditions are displayed on control panel 10 through various displays, gauges and monitors. The wires for the various sensors, motors and heaters may pass through or are connected to the positionable support bracket 112.

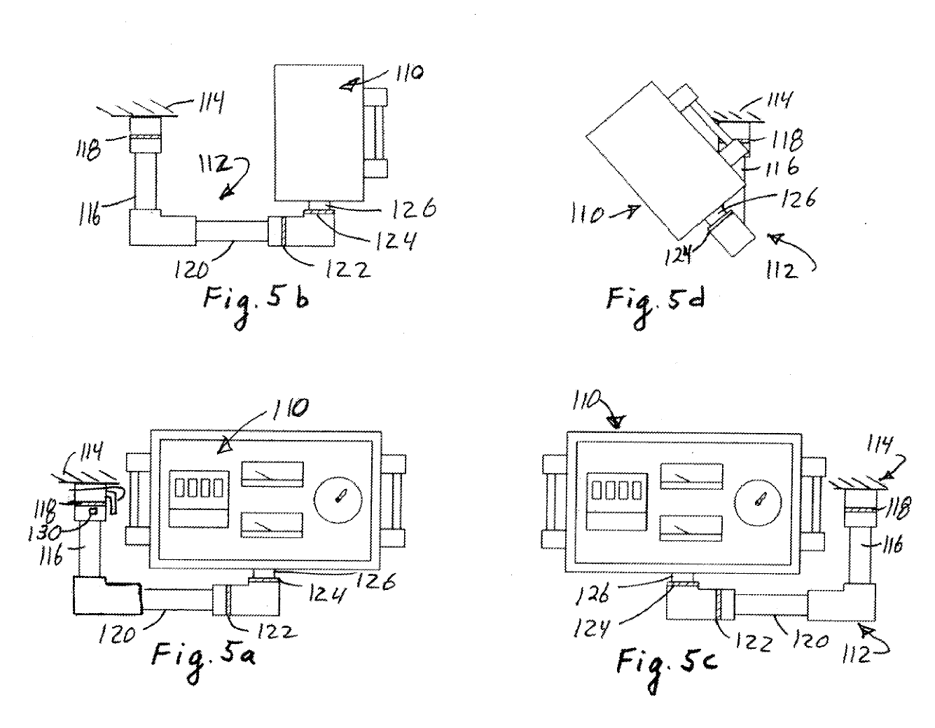

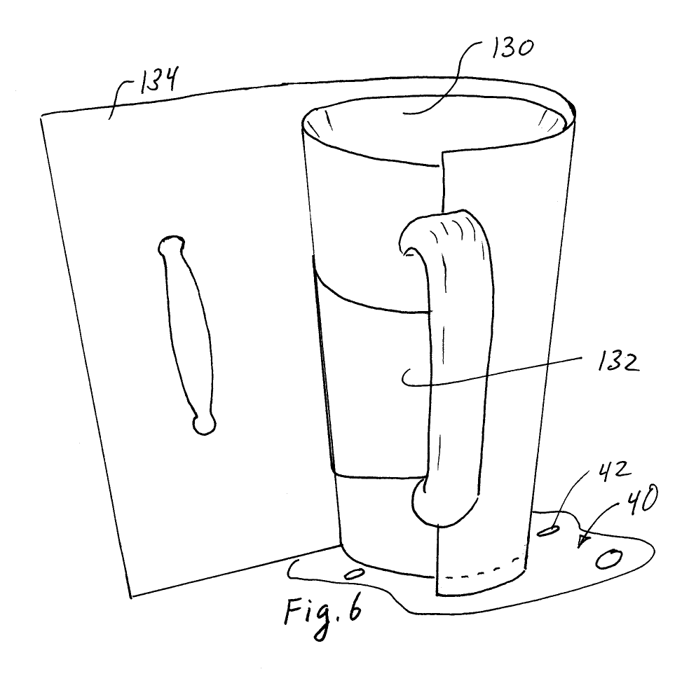

Referring to FIGS. 3 and 5a-5c, the positionable support bracket 112 preferably comprises three tubes connected to form a general U-shape with two vertical legs joined by a bottom, horizontal leg, with each leg having a rotational joint allowing rotation about the longitudinal axis of each leg. The top of the first vertical leg 116 of the U shaped bracket 112 mounted vertically from a leg 102 or cross brace 104. In the depicted embodiment, a fixed mounting bracket 114 has one surface connected to a side of the left front leg 104 of frame 100. Bolts or screws may be used or the bracket 114 may be welded to the leg 104 if it is made of metal. The upper end of vertical leg 116 has a rotating joint 118 connected to a second, downward facing surface of the fixed mounting bracket 114. Thus, the first vertical leg 116 rotates about a vertical axis relative to support leg 102 and frame 100. The second leg, horizontal leg 120 has one end joined to the bottom end of the first leg 114 by a right angle joint or elbow joint. The other end of horizontal leg 120 has a second rotating joint 122 which allows rotation about the horizontal axis of second leg 120. The second rotational joint 122 connects to another right angle joint or elbow joint which connects to a third rotating joint 124 and third leg 126. The third rotating joint 124 rotates about an axis parallel to the axis about which the first rotatable joint 118 rotates, both of which are preferably vertical axis. The bottom of the control panel 110 is connected to the other end of the third leg 126.

The first rotatable joint 118 allows rotation about a first longitudinal axis along the vertical first leg 116 of the U-shaped bracket. That first rotation allows the bottom of the U shaped bracket (second leg 120) to be oriented anywhere in a horizontal plane, and allows that bottom leg or second leg 120 to be oriented in that horizontal plane at various positions. The second rotatable joint 122 allows rotation about the horizontal axis of that bottom leg or second leg 120. The third rotatable joint 124 allows rotation along a third axis parallel to the first axis of first leg 116. The legs and rotatable joints thus allow rotation about two vertical but offset axes each extending along first and third legs 116, 126. The second rotatable joint 122 allows the third leg 126 and control panel 110 to rotate about an axis in the horizontal plane which axis extends along the second leg 120. Because that second leg 120 (the bottom of the U-shaped bracket 112) can rotate about the vertical axis of first leg 116, the control panel can be positioned in a great many positions and orientations. The control panel 110 may thus rotate about the vertical axis through leg 116 at a radius set by the distance between vertical axes through vertical legs 116, 126. The control panel 120 may rotate about the horizontal axis through horizontal leg 120 a distance that varies with the length of the third leg 126 which offsets the control panel from the second rotational axis through second leg 120. The legs 116, 120, 126 may be of different lengths in order to avoid hitting legs 102 or cross-members 104 and to position the control panel 110 at a desired location. The rotational joints 118, 122, 124 rotate about one axis, the longitudinal axis of a leg, and may be at either end of a leg.

The legs 116, 120, 126 of the U shaped positionable bracket 112 are preferably tubular with control wires and sensor wires passing through the tubes with sufficient room in the tubes and wire length to allow bending and/or rotating of the wires at the three rotatable joints 118, 122, 124, while maintaining electrical contact and signal contact through the wires. This multi-axis rotation bracket 112 allows the control panel 110 to be moved laterally to either side of the leg 102 and support frame 100. It also allows the control panel to extend inward or outward from the periphery of the support frame 100 by rotation along the first axis along first leg 116. It further allows the control panel to face left, right or forward by rotation about the third axis along third leg 126 so the panel can be viewed from various angles in the horizontal plane. Combined rotation about the second and third axes through the second and third legs 120, 126 allows the control panel 110 to be rotated in horizontal and vertical axes to allow a user to view the control panel by looking downward from various angles. The multi axis rotation about two vertical axes and one horizontal axis allows great flexibility in accessing the control panel 110 and great flexibility in viewing information displayed on the control panel, while reducing the flexing of wires passing through the support bracket so as to maintain electrical and signal communication. The ease and flexibility of viewing angles and access to the control panel 110 are thus increased.

Referring to FIG. 5a, the rotation of legs 116, 130, 126 may be limited by using one or more stops 128, 130 on opposing sides of rotating joint 118, 122, 124, configured and located so that the stop on one part of the joint hits a stop on the other part of the joint to limit rotation. Thus, stop 128 on one side of rotating joint 118 may abut stop 130 on the opposing side of the joint 118 to limit relative rotation to 360°, while adding two stops 130 spaced 180° apart so they are on diametrically opposite sides of the leg 116 will limit relative rotation to 180° while two stops 130 spaced 90° apart and on opposing sides of stop 128 could limit relative rotation to 90°. The relative rotational limits vary with user preferences but it is believed advantageous to limit rotation of first and second joints 118 and 122 to about 180° while limiting rotation of the third joint 126 to about 90°.

Referring further to FIG. 6, the thermal furnace 10 is believed especially useful for workpieces 130, such as a mug, having a dye transfer image on a sheet of removable material 132 that is resiliently urged against the workpiece by a tensioned sheet of silicon rubber 134, as described in U.S. Pat. No. 8,002,931, the complete contents of which are incorporated herein by reference.

Referring to FIGS. 4 and 6, in use, the surface on each of a plurality of workpieces 130 are wrapped or otherwise placed in contact with an image bearing or formed of sublimation transfer dye with each image each facing a surface of the workpiece. The images are often on a transfer material or placed directly onto the surface as by spraying or other transfer mechanism. The image is resiliently urged against the workpiece surface by an thermally suitable elastomeric material with sufficient pressure for sublimation transfer. The furnace door 20 is opened to uncover access opening 18. A plurality of wrapped images and workpieces are placed on the rotating support 42. The support 42 moves the workpieces 130 past the flexible curtain formed by strips 90 and through the heated workspace 52 of the furnace for a time sufficient for sublimation transfer of the dyes onto the workpiece 130. The door 20 may be closed and opened when the sublimation process is complete to again allow access to the access opening 18 and removal of completed, imaged workpieces via the access opening. Alternatively, the door 20 may be left open and the access opening 18 left uncovered with new workpieces continuously added while completed workpieces are continuously removed, with the curtains restricting excessive heat loss and with the rotational speed set to complete the thermal transfer of the image within one revolution, or within a specified number of revolutions of rotating support 40 through the access space 18. The rotating workpiece support 42 allows a single worker to load and unload workpieces from a single location, in a continuous process. The vertical access allowed by the opening in top 14 allows easy insertion and removal of workpieces. For workpieces requiring multiple rotations the operator may leave the workpieces in place for the desired number of revolutions or may move the workpieces continually outward or inward with the radial location on the support 40 reflecting the number of revolutions, using markings on the support 42 or the concentric circles of air holes 42 to reflect the number of revolutions, with the imaged workpieces removed after the desire number of revolutions. For workpieces requiring a long enough processing time to warrant closing the door 20 the vertical access of opening 18 allows fast heat escape from the access opening 18 because the heat rises. That allows fast access by the operator to the rotating support 40 though that access opening even when the furnace door 20 is just opened. The curtains via the movable strips 90 maintain heat in the working space 52 of the furnace whether the door 20 is open or closed to reduce heat loss. Recirculating heat via fan blade 80 and plenums 63, 65 helps maintain the furnace temperature in the operating space 52 and improve efficiency. For periods of non-use where it is inefficient to shut off the furnace 10, the door 20 may cover the access opening 18 to reduce heat loss. The control panel 110 may be rotated into various positions for access by the operator or for monitoring of the furnace by the operator or for easily adjusting the furnace operating parameters such as temperature, air circulation flow, and the rotational speed of the workpiece support 40.

The furnace 10 thus advantageously allows an improved method of sublimation coating of workpieces as the continuous insertion of un-images workpieces onto the rotating support 42 and the continuous removal of imaged workpieces from the same location, by the same operator, is much faster and more efficient than the prior art which used single workpiece devices or single ovens with a single door, or that used long tunnels requiring multiple operators.

The following is a summary of the part numbers and associated parts used herein. 10—furnace; 12—sidewall of furnace; 14—outer top of furnace; 16—outer bottom of furnace; 18—access opening to furnace; 20—door to furnace; 22—side part of access opening in top; 24—side part of access opening in top; 26—side edge of access opening in sidewall; 28—side edge of access opening in sidewall; 30—bottom edge of access opening in sidewall; 32—top of door; 35—side cover of door; 35—longitudinal axis; 36—viewing port; 38—handle on door; 40—rotating support; 42—air holes in support; 44—support motor; 46—shaft of support motor; 52—workspace; 62—inner sidewall; 63—side plenum; 64—inner top; 65—top plenum; 66—inner bottom; 68—bottom vent opening; 70—top vent opening; 76—top fan motor; 78—fan shaft; 80—fan blade; 82—first, bottom heater; 84—second, top heater; 86—third, side heater; 90—strips forming curtains; 92—support for curtain strips; 94—support rail for door; 100—furnace support; 102—leg of support frame; 104—cross-brace between legs; 106—wheel; 108—flange; 109—top plate; 110—control panel; 112—positionable support bracket; 114—fixed mounting support; 116—first leg; 118—first rotating joint; 120—second leg; 122—second rotating joint; 124—third rotating joint; 126—third leg; 128—stop.

The above description illustrates many features of the improved furnace and is given by way of illustration, not limitation. One of ordinary skill in the art will appreciate that the useful features of the air circulation, cylindrical shape, and multi-axis mount for the control panel, may be modified or replaced by equivalent structure without departing from the spirit and scope of the disclosure. For example, the outer top 14 is shown as generally flat but other shapes could be used, including slightly domed surfaces. Likewise the sidewalls 12, 62 could be polyhedrons rather than circular. Thus, while detailed embodiments of the furnace, support frame and multi-axis support for the control panel are disclosed, it is to be understood that the disclosed embodiments are merely exemplary, not limiting. Further, the various features of this invention can be used alone, or in varying combinations with each other and are not intended to be limited to the specific combination described herein. Thus, the invention is not to be limited by the illustrated embodiments.

What is claimed is:

1. A thermal furnace for sublimation transfer, comprising:
a cylindrical furnace having a longitudinal axis and a circular outer sidewall with an outer top and an outer bottom opposite the top and joined to the outer sidewall, the furnace having an inner sidewall spaced inward of the outer sidewall to form a side plenum between the inner and outer sidewalls, the furnace having an inner top spaced inward of the outer sidewall to form a top plenum between the inner and outer tops, the side and top plenums being interconnect around at least a part of the outer periphery of the inner sidewall, the side plenum being in fluid communication with a workspace inside the inner sidewall through a plurality of sidewall ventilation openings extending through the inner sidewall, the top plenum being in fluid communication with the workspace through a ventilation opening in the top inner wall;
the furnace having first and second top side parts inclined relative to each other to form opposing sides of a V-shaped top access opening that extends through the inner and outer tops to an outer periphery of the tops, with the first top side part joining the outer and inner tops to close the top plenum along the first top side part and with the second top side part joining the outer and inner tops to close the top plenum along the second top side part of the V-shaped access opening;
the furnace also has a first sidewall edge extending downward from an outer end of the first top side part and has a second sidewall edge extending downward from the second top side part with a bottom sidewall edge joining the first and second sidewall edges to form a side access opening extending through the first and second sidewalls, the first and second sidewall edges joining the inner and outer sidewalls to close the side plenum along the first and second sidewall edges, the bottom sidewall edge joining the inner and outer sidewalls to close the side plenum along the bottom sidewall edge;
a movable door having a door top sized to cover the V-shaped access opening in the top of the furnace and rotatably mounted at the center of the top, the door having a depending cover large enough to cover the side access opening in the furnace sidewall and located close to that side access opening, the depending cover being curved to allow rotation of the cover to pass along the outer periphery of the sidewall when the cover is rotated about the longitudinal axis to cover and uncover the side and top access openings;
a rotating workpiece support inside the furnace and below the bottom sidewall edge, the rotating workpiece support having a plurality of air holes extending through the support;
a motor located outside the furnace and mechanically coupled to the rotating workpiece support;
an electrical resistance heating element located inside the furnace; and
a fan circulating air through the plenum.

2. The thermal furnace of claim 1, wherein when viewed along a radial axis the first and second sidewall edges are parallel to each other and the bottom edge is horizontal to form a rectangular access opening.

3. The thermal furnace of claim 1, wherein the door top is triangular shaped.

4. The thermal furnace of claim 1, wherein the door top is trapezoidal shaped.

5. The thermal furnace of claim 3, wherein the door top is rotatably mounted at the center of the outer top.

6. The thermal furnace of claim 1, wherein the door cover is movably supported on a ledge extending along an outer periphery of at least one of the inner and outer walls.

7. The thermal furnace of claim 1, wherein the heating element is below the rotating workpiece support and above a bottom of the inner wall.

8. The thermal furnace of claim 1, wherein the heating element extends along the top inner wall.

9. The thermal furnace of claim 1, wherein the heating element extends along the sidewall.

10. The thermal furnace of claim 1, wherein the ventilation opening in the top inner wall includes a ventilation opening at the center of the wall.

11. The thermal furnace of claim 1, wherein the plurality of ventilation openings extending through the sidewall are located below the rotating workpiece support.

12. The thermal furnace of claim 1, wherein the top ventilation opening in the top inner wall includes a ventilation opening at the center of the inner wall and wherein the fan has a motor located outside the furnace that is in mechanical communication with a fan blade located above that top center ventilation opening, with the fan blade configured and rotated so as to draw air from the workspace into the top plenum.

13. The thermal furnace of claim 1 wherein the fan circulates air out the top ventilation opening, then through the plurality of ventilation openings in the sidewall and then upward through the air holes in the rotating workpiece support.

14. The thermal furnace of claim 1, wherein the outer bottom has an annular shape which joints to the inner sidewall which extends in a direction along the longitudinal axis of the furnace a distance beyond the outer bottom, and wherein a bottom of the inner sidewall is closed by an inner bottom, the rotating workpiece support being located above the outer bottom and inner bottom, with at least the inner sidewall and inner top being insulated.

15. The thermal furnace of claim 1, wherein the furnace is on a support frame having sufficient wheels to allow movement of the furnace on a surface.

16. The thermal furnace of claim 1, further comprising a control panel for the furnace, the control panel mounted on a multi-axis support comprising:
a first leg having a first rotatable joint rotating about a first longitudinal axis of the first leg and connected to either the furnace or a support frame on which the furnace is placed;
a second leg connected to the first leg at a location which allows the first joint to rotate the second leg about the first longitudinal axis, the second leg having a second rotatable joint rotating about a second longitudinal axis of the second leg; and
a third leg connected to the second leg at a location which allows the second joint to rotate the third leg about the second longitudinal axis, the third leg having a third rotatable joint rotating about a third longitudinal axis of the third leg, the control panel being connected to either the third leg or third joint to rotate about the third axis.

17. The thermal furnace of claim 16, wherein the first and third longitudinal axes are parallel and the second longitudinal axis is perpendicular to the first axis.

18. The thermal furnace of claim 17, wherein the first rotatable joint is connected to the support frame and the first axis is vertical.

19. A thermal furnace for sublimation transfer, comprising:
a cylindrical furnace having a longitudinal axis and a circular outer sidewall with an outer top and an opposing outer bottom;
the furnace having first and second top side parts inclined relative to each other to form opposing sides of a V-shaped top access opening in the outer top which top access opening extends to an outer periphery of the top, the furnace having a first sidewall edge extending downward from an outer end of the first top side part and has a second sidewall edge extending downward from the second top side part with a bottom sidewall edge joining the first and second sidewall edges to form a side access opening in the sidewall;
a movable door having a door top sized to cover the V-shaped access opening in the top of the furnace and rotatably mounted about the longitudinal axis of the furnace, the door having a depending cover large enough to block the side access opening in the furnace sidewall, the depending cover curved to allow rotation of the cover to pass along the outer periphery of the sidewall when the cover is rotated about the longitudinal axis;
a rotating workpiece support inside the furnace and below the bottom sidewall edge, the rotating workpiece support having a plurality of air holes extending through the support;
a motor located outside the furnace and mechanically coupled to the rotating workpiece support;
an electrical resistance heating element located inside the furnace; and
a fan circulating air through the plenums.

20. The thermal furnace of claim 19, further comprising:
an inner top inward of the outer top and having a V-shaped access opening in the inner top located to correspond with the V-shaped access opening in the outer top, the space between the inner and outer tops forming a top plenum, the first and second top side parts extending between the outer and inner tops to close the top plenum at the V-shaped top access opening that now extends through the inner and outer tops,
an inner sidewall located inward of the outer sidewall and having a side access opening corresponding to the side access opening of the outer sidewall, the space between the inner and outer sidewalls forming a side plenum, the first and second sidewall edges and bottom sidewall edge extending between the first and second sidewalls to close the side plenum at the side opening that now extends through the outer and inner side walls, the top plenum intersecting the side plenum to place the two plenums in fluid communication;
the inner top having a top ventilation opening in fluid communication with a workspace enclosed by the inner top and inner sidewall, the top ventilation opening being in fluid communication with the top plenum, the bottom sidewall having a plurality of sidewall ventilation openings extending therethrough to place the side plenum in fluid communication with the workspace, the rotating table being above at least some of those ventilation openings in the sidewall.

21. The thermal furnace of claim 20, wherein the heater is located at least at one of the top of the inner wall or below the rotating workpiece support.

22. The thermal furnace of claim 20, further comprising a wheeled support on which the furnace is placed.

23. The thermal furnace of claim 22, further comprising a control panel for the furnace, the control panel mounted on a multi-axis support mounted to one of the furnace or the wheeled support, the multi-axis support comprising:
a first leg having a first rotatable joint rotating about a first longitudinal axis of the first leg and connected to either the furnace or a support frame on which the furnace is placed;
a second leg connected to the first leg at a location which allows the first joint to rotate the second leg about the first longitudinal axis, the second leg having a second rotatable joint rotating about a second longitudinal axis of the second leg; and
a third leg connected to the second leg at a location which allows the second joint to rotate the third leg about the second longitudinal axis, the third leg having a third rotatable joint rotating about a third longitudinal axis of the third leg, the control panel being connected to either the third leg or third joint to rotate about the third axis.

24. The thermal furnace of claim 23, wherein the first and third longitudinal axes are parallel and the second longitudinal axis is perpendicular to the first axis.
